(19) United States
(12) Patent Application Publication
(10) Pub. No.: US 2006/0033635 A1
(43) Pub. Date: Feb. 16, 2006

(54) Casing assembly for burglar alarms

(76) Inventor: Yi-Chen Chen, Taoyuan County (TW)

Correspondence Address: BIRCH STEWART KOLASCH & BIRCH, PO BOX 747, FALLS CHURCH, VA, 22040-0747, US

(21) Appl. No.: 10/915,481

(22) Filed: Aug. 11, 2004

(51) Int. Cl. G08B 23/00

(52) U.S. Cl. 340/693.6; 340/541

(57) ABSTRACT

The present invention discloses an improved casing assembly for burglar alarm, and the casing comprises an upper casing, a chassis and a front panel; wherein a circuit board and a speaker are included in the upper casing and the chassis and the front panel is covered on the exterior of the upper casing and locked with the chassis by a lock as a whole. The assembly of the forgoing components is connected by the corresponding coupling components on the assembly and thus does not require additional coupling device, which makes the assembly much simpler and quicker and has the advantages of lowering the manufacturing and labor costs. In the meantime, the printed circuit according to the present invention is coupled to a vibration switch or magnetic spring switch as a sensor triggering source for acting as a trigger of the burglar alarm for motor vehicles, portable objects, displayed items, doors and windows, security or display windows. All these burglar alarms can share the same casing and thus can save the cost for manufacturing the molds. The casing can go with a rope having a metal head for passing through, suspending at or fixing onto a wall to give an excellent antitheft protection effect.

### BACKGROUND OF THE INVENTION

1. Field of the Invention

The present invention relates to an improved casing assembly for burglar alarms, more particularly to a design of casing assembly that does not require screws for its fixture and has a close assembly which prevents break-in by external forces, and such design fits the installation for motor vehicles, portable objects, displayed items, windows and doors, security or display windows by passing, suspending or fixing the casing assembly onto a wall.

2. Description of the Related Art

A burglar alarm is a device for generating a shrill noise to scare away a burglar or identify an unauthorized intrusion. To achieve these objectives, a burglar alarm primarily relies on the precise of its detection for a slight movement and prevents the burglar alarm from being damaged or disabled by external forces. Regardless the detection methods, most of the current burglar alarms use screws or similar components to assemble the internal circuit board, the alarm siren and the external casing. Such assembling method has the following shortcomings:

1. It is necessary to assign several persons along a production line for assembling the burglar alarm, and a person is assigned to be responsible for installing a circuit board, an alarm siren and an external casing. Therefore, the labor cost and material cost will be very high.

2. When a burglar alarm incorporating screws for its fixture is in use, special attention about the positions of the hidden screws must be paid, or else the screw holes will be exposed and can be opened or damaged easily.

3. The positions of all screw holes of a burglar alarm incorporating screws for its fixture are located at the bottom, and such arrangement makes the change of battery very inconvenient for a burglar alarm that is installed onto a wall.

4. If the burglar alarm incorporating screws for its fixture adopts a vibrating source as its triggering method, a steel rope is usually fixed onto a main body, and a buckle is generally used to couple the handle of a portable object. It is unable to pass the steel rope through the handle of a portable object or the steering wheel of a motor vehicle, and thus it is very easy for a burglar to remove the burglar alarm by hands.

Therefore, the architecture of a burglar alarm that incorporates screws for its fixture incurs higher labor cost and material cost for securing the screws and has the shortcomings of having an easily damaged and inconvenient screw hole and a limitation on the screw positions that does not allow a steel rope to pass through or fix a steel rope onto a wall by suspension at the same time. Such architecture definitely needs further improvements.

### SUMMARY OF THE INVENTION

Therefore it is the primary objective of the present invention to provide an improved casing assembly for burglar alarms, which uses corresponding coupling components for the connection without using additional coupling devices to provide a simple and quick assembly and also features the advantage of lowering the assembling cost. In addition, the close connections between components can effectively prevent the burglar alarm from being damaged by external forces.

To achieve the foregoing objective, the present invention comprises an upper casing, a chassis and a front panel, wherein a circuit board and a speaker are included in the upper casing and the chassis, and the front panel is covered onto the exterior of the upper casing and locked with the chassis integrally by a lock. An embedding plate extended from the bottom edge along the periphery of the front panel is coupled tightly with a groove extended around the chassis, and thus the burglar alarm cannot be damaged easily by external forces.

Another objective of the present invention is to install two interconnected hollow pillars with unequal diameters, and these two hollow pillars are disposed on the upper casing; a through hole disposed on the chassis at a position corresponding to the hollow pillar having a larger diameter, such that a steel rope having a metal head is passed through the through hole of the chassis into the hollow pillar having a larger diameter, and then coupled with the hollow pillar having a smaller diameter. The front panel covers the hollow pillars such that the steel rope will not fall out and the burglar alarm can be tied with the handle or a steering wheel for protecting the desired object.

A further objective of the present invention is to build a corresponding slot on the chassis, the hollow pillars and the front panel, so that an electric wire can be connected to the magnetic spring switch from the outside through the slots, which gives another way of using the burglar alarm such that the casing assembly can fit different types of burglar alarms and achieve the effect of saving the mold manufacturing cost.

### BRIEF DESCRIPTION OF THE DRAWINGS

The above objects, features and advantages of the present invention will become apparent from the following detailed description taken with the accompanying drawing. However, these drawings are provided for reference and illustration and not intended to act as a limitation to the present invention.

FIG. 1 is an exploded view of the casing assembly according to the present invention.

FIG. 2 is another exploded view of the casing assembly according to the present invention.

FIG. 3 is an illustrative view of a steel rope being coupled to a protected object according to the present invention.

FIG. 4 is an illustrative view of the casing assembly being coupled to the front panel and chassis by a lock according to the present invention.

FIG. 5 is an illustrative view of the rotary plate being separated from the lock after the casing assembly is coupled to the front panel and chassis by a lock as depicted in FIG. 4.

FIG. 6 is an illustrative view of the casing assembly being coupled to a protected object by suspension according to the present invention.

FIG. 7 is an exploded view of the magnetic spring switch according to the present invention.

FIG. 8 is an illustrative view of the assembled magnetic spring switch as depicted in FIG. 7.

### DETAILED DESCRIPTION OF THE PREFERRED EMBODIMENTS

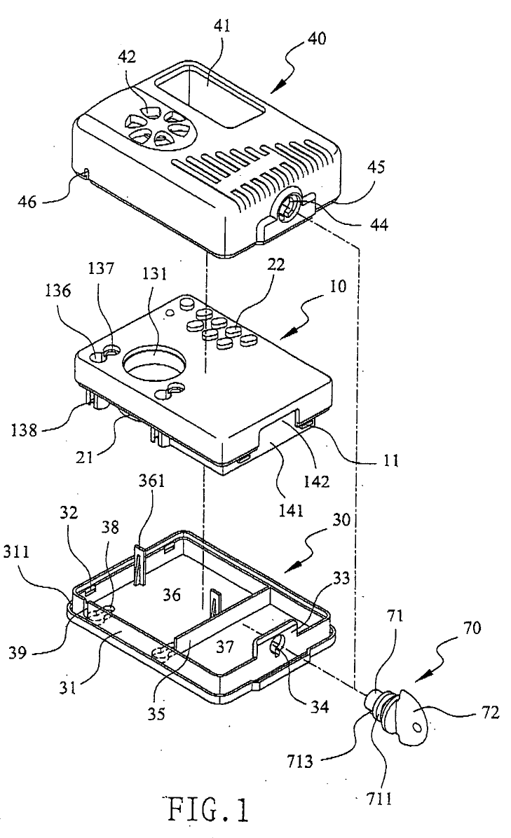

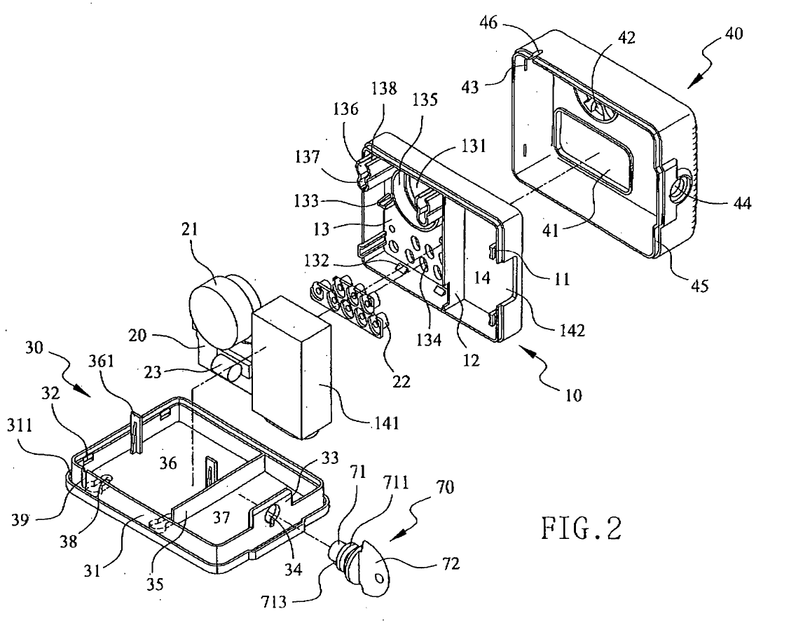

Please refer to FIGS. 1 and 2 for exploded views at two different angles of the casing assembly according to the present invention. The casing assembly for a burglar alarm comprises the following elements:

An upper casing 10 defines an embedded accommodating space and has at least one latch pillar 11 individually disposed on both sides of the upper casing 10, and a partition board 12 divides the accommodating space into two sections: a circuit board accommodating section 13 and a battery accommodating section 14; wherein the circuit board accommodating section 13 comprises a latch set for retaining a circuit board 20 and a hollow cavity 131 for retaining a speaker 21, and the latch set is comprised of at least one press latch bracket 132 disposed at the internal edge of the casing of the upper casing 10 and at least one limit plate 133 disposed at a distance equal to the width of the circuit board 20 from the internal edge of the upper casing 10, and a plurality of press key holes 134 is disposed between the press latch brackets 132 for installing and exposing a plurality of press keys of the circuit boards. The hollow cavity 131 comprises a surrounding plate 135 for mounting the loudspeaker 21, two interconnected hollow pillars 136, 137 having unequal diameters being disposed on both sides of the surrounding plate 135 and a corresponding slot 138 individually disposed on two hollow pillars 136, 137.

The battery accommodating section 14 is used for installing a battery 141 and an opening 142 is disposed at one side of the upper casing 10.

A chassis 30 comprises a surrounding plate 31 disposed around the chassis 30 in corresponsive to an area on the upper casing 10, so that the chassis 30 and the upper casing 10 are coupled to form a closed casing, and a groove 311 is defined between the surrounding plate 31 and the chassis 30, and a latch hole 32 corresponding to the latch pillar 11 of the corresponding upper casing 10 is provided, and an extending plate 33 corresponding to the foregoing opening 142 is protruded from the surrounding plate 31, and a key hole 34 is disposed on the extending plate 33.

The foregoing surrounding plate 31 encloses an area, and such area is divided by a partition board 35 into two sections: a circuit board accommodating section 36 and a battery accommodating section 37. The circuit board accommodating section 36 comprises two press plates 361 for pressing on the circuit board 20 and a through hole 38 is disposed at the hollow pillar 136 having a larger diameter. Further, the surrounding plate 31 comprises a corresponding notch 39 disposed on the surrounding plate 31 at a position corresponding to the open groove 138 of the two hollow pillars 136, 137.

A front panel 40 covers the exterior of the upper casing 10 and is installed onto the chassis 30. The front panel 40 comprises a plurality of through holes 41, 42 disposed at the positions corresponding to the press key holes 134 and the hollow cavity 131 of the upper casing 10; a latch plate 43 disposed on an internal edge at a position corresponding to the latch hole 32 of the chassis 30; a key hole 44 disposed on the other edge at a position corresponding to the key hole 34 of the chassis 30; and an embedded plate 45 extended from the bottom edge disposed around the front panel 40.

Further, a corresponding notch 46 is disposed on a lateral side of the front panel 40 at a position corresponding to the notch 39 of the chassis 30.

Every press key 22 of the electric conductive press key rubber passes through the press key hole 134 so that every press key 22 is exposed to the outside, and the circuit board 20 is disposed on the electrically conductive rubber and one side of the circuit board 20 is engaged into the press latch bracket 132 and the other side is limited by the limit plate 133 and fixed into the circuit board accommodating section 13 of the upper casing 10. The speaker 21 is mounted by the surrounding plate 135 around the hollow cavity 131. The battery 141 is installed in the battery accommodating section 14.

The upper casing 10 is covered onto the chassis 30, such that the latch pillar 11 is latched into the latch hole 32 of the chassis 30 as a whole, and then:

1. The press plate 361 of the chassis 30 presses against the circuit board 20, so that the circuit board 20 is mounted between the upper casing 10 and the chassis 30 and the circuit board 20 will not fall out easily due to the pressing force exerted on the press keys 22.

2. The two hollow pillars 136 having a larger diameter are corresponsive to the through hole 38 of the chassis 30, and the slots 138 of the two hollow pillars 136, 137 are corresponsive to the notch 39 disposed at the surrounding plate 31 corresponding to the chassis 30.

3. The extending plate 33 of the chassis 30 matches the opening 142 of the upper casing 10 as to seal the opening 142.

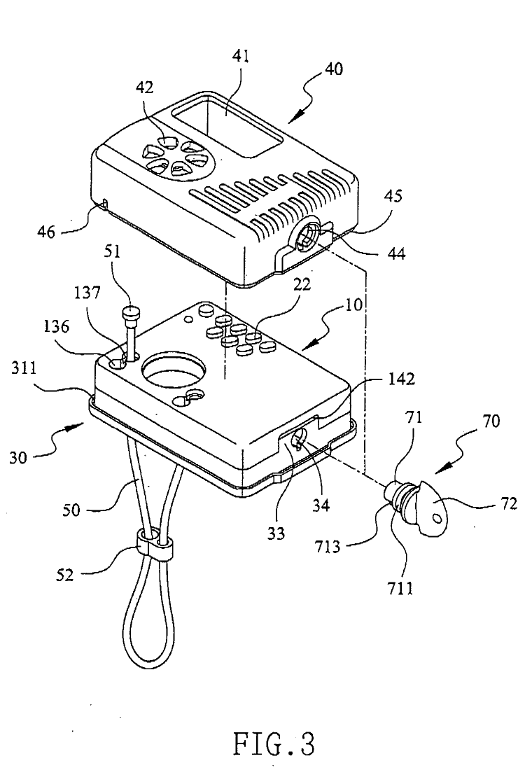

Please refer to FIG. 2 for the vibration switch 23 being used as a triggering source for enabling the circuit board 20 of the burglar alarm and coupling a protected object by a suspension method. In FIG. 3, a steel rope 50 having a metal head 51 on each of both ends serves as a coupling member for the suspension. The steel rope 50 passes through an adjusting ring 52 to adjust the tightness of the suspension of the protected object.

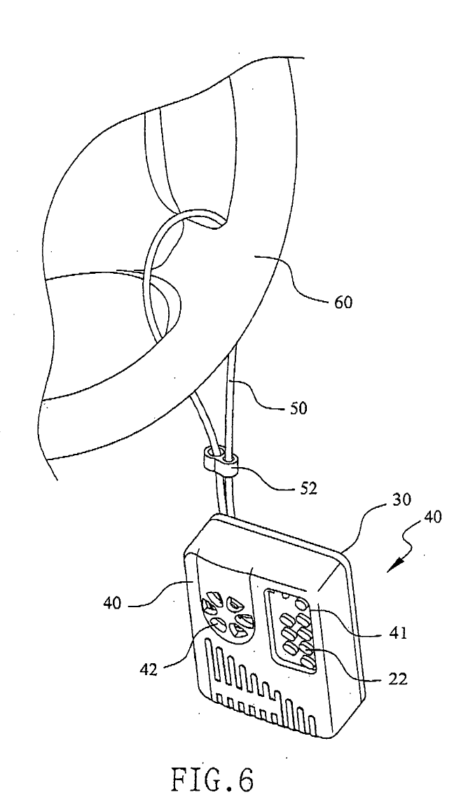

One end of the steel rope 50 passes through the through hole 38 of the chassis 30 and enters into the hollow pillar 136 having a larger diameter, such that the steel rope 50 is moved to the hollow pillar 137 having a smaller diameter, and the metal head 51 is latched into the hollow pillar 137 having a smaller diameter. After the other end of the steel rope 50 passes through the protected object (such as the handle of a display window, the handle of a portable object or the steering wheel of a motor vehicle) as shown in FIG. 6, the same assembling method is used to couple the metal head 51 at the other end of the steel rope 50 into the hollow pillar 137 having a smaller diameter, and then the front panel 40 is covered onto the exterior of the upper casing 10. The latch plate 43 disposed on the internal edge of one side of the front panel 40 is latched into the latch hole 32 of the chassis 30, and the other side corresponds to the key hole 34 of the chassis 30 so that the embedding plate 45 disposed at the bottom edge is placed into the groove 311 of the chassis 30 as to seal the hollow pillar 137 having a smaller diameter and coupling with a metal head 51. The steel rope 50 will not fall out easily as the front panel 40 is tightly coupled with the chassis 30.

A lock 70 is provided in the present invention, which comprises a detachable lock head 71 and a rotary plate 72, and the lock head 71 is substantially cylindrical in shape and has a stop ring extended from one end of the periphery and a groove 712 for inserting the rotary plate 72 at the center, and a protruded pillar 713 disposed at the other end to form the pattern corresponding to the key holes 34, 44 of the chassis 30 and the front panel 40.

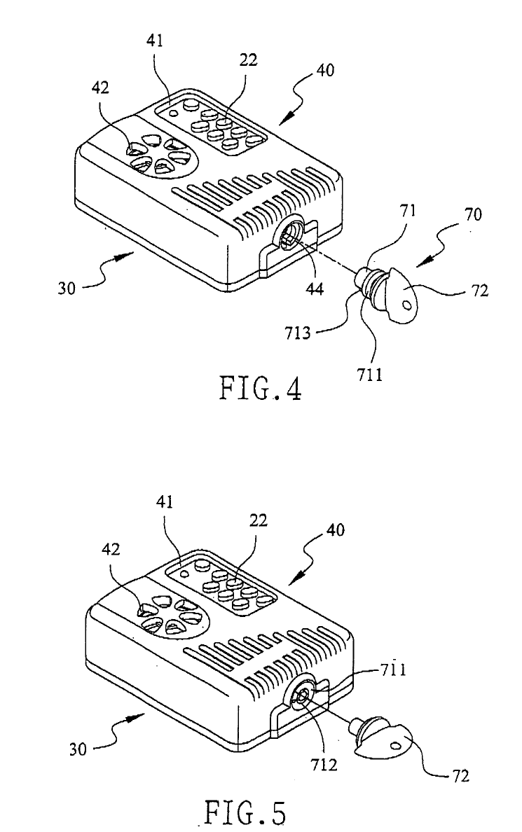

After the lock 70 is inserted into the key holes 34, 44 and rotated by the rotary plate 72, the lock head 71 is shifted to an angle, so that the chassis 30 and the front panel 40 are coupled as a whole, and the rotary plate 72 is withdrawn from the lock head 71. The lock head 71 remains in the internal surface of the key hole 34 of the chassis 30 due to the protruded pillar 713 is limited by the casing of the chassis 30 as shown in FIGS. 4 and 5.

Similarly, if it is necessary to change batteries 141 or remove the burglar alarm, the rotary plate 72 rotates the lock head 71 to the positions corresponding to the key holes 34, 44 in order to remove the lock head 71 from the burglar alarm. Therefore, the front panel 40 can be separated from the chassis 30 and the chassis 30 can be separated from the upper casing 10.

If the present invention is applied for the installation on a door, a window or a wall, it only needs to stick a double-sided adhesive tape on the chassis 30 or uses screws to fix the chassis 30.

Since there is no screw hole on the burglar alarm according to the present invention, therefore it is not necessary to hide any screw hole and thus does not have any concern on the limitations of installation. The suspension method can be adopted to couple the protected object or fixed onto a window or a door. Any slight vibration will trigger the vibration switch 23 and the burglar alarm. The coupling structure is simple and easy for the installation, and also can lower the labor cost for its production, and provides a convenient way for its installation.

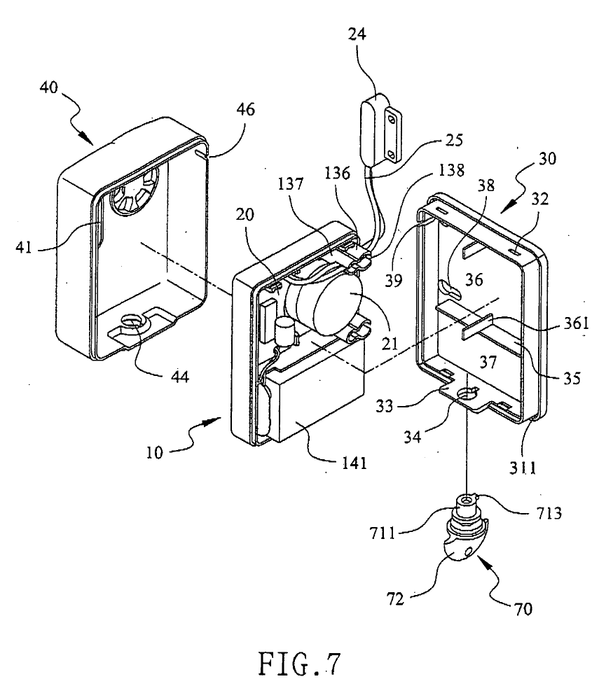

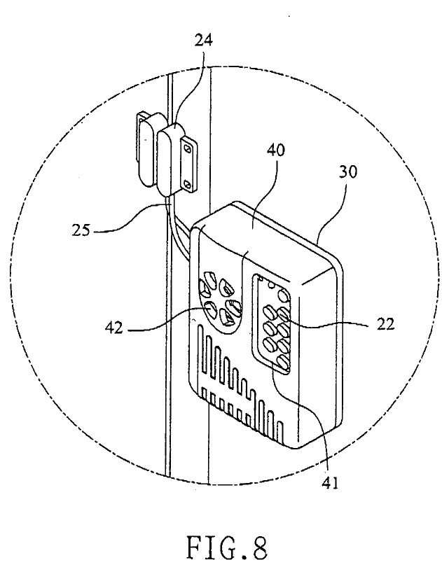

The vibration switch 23 of the circuit board 23 as shown in FIG. 7 could be substituted by a magnetic spring switch 24. The electric wire 25 connected to the circuit board 20 and the magnetic spring switch 24 is passed through the slot 138 of the mutually corresponsive hollow pillars 136, 137, the notch 39 of the chassis 30 and the notch 46 of the front panel 40 and then is passed outside the casing of the burglar alarm. The magnetic spring switch 25 is extended out of the casing of the burglar alarm, and individually installed onto both sides of the door as shown in FIG. 8, so that burglar alarms with different triggering sources can share the same casing assembly as to achieve the effect of reducing the mold production cost.

The improved casing assembly for the burglar alarm according to the present invention effectively overcomes the shortcoming of the connection by screws and further complies with the patent application requirements and is submitted to the Patent and Trademark Office for review and granting of the commensurate patent rights.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. An improved casing assembly for burglar alarms, comprising:
an upper casing, having at least one latch pillar individually disposed on both sides of said upper casing, a latch set for retaining a circuit board and a hollow cavity, and said hollow cavity having a surrounding plate disposed around said hollow cavity for mounting a speaker, and said surrounding plate having two interconnected hollow pillars with unequal diameters disposed on both sides of said surrounding plate;
a chassis, having a surrounding plate for enclosing an area corresponding to said upper casing, a slot formed between said surrounding plate and said chassis, a latch hole corresponding to said latch pillar, a through hole individually disposed at said hollow pillar having a larger diameter and a key hole disposed on said surrounding plate; and
a front panel, being covered onto the exterior of said upper casing and installed onto said chassis, and having a latch plate disposed on an internal edge of said front panel corresponding to said latch hole of said chassis, and a key hole disposed on another side corresponding to said key hole of said chassis, and an embedded plate extended from a bottom edge around the periphery of said front panel corresponding to said slot;
thereby the foregoing element constituting a casing for a burglar alarm without using screws for the fixture and being tightly assembled to prevent said casing assembly from being opened by an external force.

2. The improved casing assembly for burglar alarms of claim 1, wherein said latch set is comprised of at least one press latch bracket disposed at the internal edge of said upper casing and at least one limit plate disposed at a distance equal to the width of said circuit board from the internal edge of said upper casing.

3. The improved casing assembly for burglar alarms of claim 1, wherein said two hollow pillars individually comprise a corresponding slot.

4. The improved casing assembly for burglar alarms of claim 1, wherein said chassis comprises two press plates for pressing on said circuit board.

5. The improved casing assembly for burglar alarms of claim 1, wherein said surrounding plate comprises a corresponding slot disposed on said slot of said two hollow pillars.

6. The improved casing assembly for burglar alarms of claim 1, wherein said front panel comprises a corresponding notch disposed on a lateral side of said front panel at a position corresponding to said notch of said chassis.

7. The improved casing assembly for burglar alarms of claim 1 further comprising a lock for locking said chassis and said front panel as a whole.

8. The improved casing assembly for burglar alarms of claim 7, wherein said lock comprises a detachable lock head and a rotary plate, and said lock head is substantially in a cylindrical shape and a stop ring is disposed at the periphery on one end and a groove is disposed in the middle for inserting said rotary plate, and a protruded pillar is disposed at another end to form a pattern of said key holes corresponding to said chassis and said front panel.

9. The improved casing assembly for burglar alarms of claim 7 further comprising a steel rope having a metal head on both ends for movably coupling with a protected object.

10. The improved casing assembly for burglar alarms of claim 3, wherein said slot disposed on said two hollow pillars, said slot of said surrounding plate and said slot of said front panel define a passage for passing and extending an electric wire out of said casing assembly after said casing assembly is assembled.
